(19) United States
(12) Patent Application Publication
(10) Pub. No.: US 2010/0142117 A1
(43) Pub. Date: Jun. 10, 2010

(54) VARIABLE CAPACITIVE ELEMENT

(75) Inventors: Takeaki Shimanouchi, Kawasaki (JP); Masahiko Imai, Kawasaki (JP); Satoshi Ueda, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/604,935

(22) Filed: Oct. 23, 2009

(30) Foreign Application Priority Data
Dec. 5, 2008 (JP) 2008-311040

(51) Int. Cl. H01G 5/011

(52) U.S. Cl. 361/278

(57) ABSTRACT

A variable capacitive element which includes a substrate; a signal line provided on the substrate; a movable electrode provided so as to cross over the signal line and having a first end and a second end which are fixed to the substrate; and a fixed capacitive portion provided between at least one of the both ends of the movable electrode and the substrate.

### CROSS-REFERENCE TO RELATED APPLICATIONS

This application is based upon and claims the benefit of priority of the prior Japanese Patent Application No. 2008-311040, filed on Dec. 5, 2008, the entire contents of which are incorporated herein by reference.

### FIELD

The embodiments relate to a variable capacitive element used in, for example, an electrical circuit in a communication device.

### BACKGROUND

A variable capacitive element is a component used in an electrical circuit, such as a variable frequency oscillator, a tuned amplifier, a phase shifter, and an impedance matching circuit. Recently, an increasing number of variable capacitive elements are mounted in a portable device. In comparison with a varactor diode, the variable capacitive element produced by using MEMS (Micro Electro Mechanical System) techniques can realize high Q value with small loss. Therefore, the variable capacitive element produced by using the MEMS techniques has been rapidly developed.

Japanese Patent Laid-Open Publication No. 2006-261480 discloses a variable capacitive element which varies the capacity by changing a distance between two opposed electrodes. FIGS. 1A and 1B show the conventional variable capacitive element. A fixed electrode 43 is provided on a substrate 41. A variable electrode 45 is supported to face the fixed electrode 43. The variable electrode 45 has an elasticity and is movable with respect to the fixed electrode 43. When a voltage is applied between the fixed electrode 43 and the variable electrode 45, an electrostatic attractive force is generated between the fixed electrode 43 and the variable electrode 45. The electrostatic attractive force causes the change of the distance between the fixed electrode 43 and the variable electrode 45 to vary the electrostatic capacitance. In order to prevent short circuit due to contact between the fixed electrode 43 and the variable electrode 45, a dielectric layer 49 is provided between these electrodes.

A digital type variable capacitive element has a minimum capacitance in a state shown in FIG. 1A, where the fixed electrode 43 and the variable electrode 45 are separated from each other. The voltage of the fixed electrode 43 and the variable electrode 45 at this time, that is, the driving voltage is represented by Voff. Meanwhile, the digital type variable capacitive element has a maximum capacitance in a state shown in FIG. 1B, where the fixed electrode 43 and the variable electrode 45 are in contact with each other through the dielectric layer 49. The driving voltage at this time is represented by Von. In the digital type variable capacitive element, those two states, that is, a state where the driving voltage is Von and a state where the driving voltage is Voff are used.

FIG. 1C is a graph showing a relation between the driving voltage (horizontal axis) and the electrostatic capacitance (longitudinal axis) in a variable capacitive element. When the driving voltage is increased, the electrostatic capacitance rapidly increases at a certain voltage. The electrostatic capacitance rapidly increases, and thereafter it becomes constant (maximum capacitance). When the driving voltage is reduced from this state, the electrostatic capacitance is rapidly reduced at a certain voltage. The electrostatic capacitance is rapidly reduced, and thereafter it becomes constant (minimum capacitance).

For example, an impedance matching circuit shown in FIG. 2 includes a signal line connecting an input terminal In and an output terminal Out and a variable capacitance connected in parallel to the signal line. When the impedance matching circuit is produced, the variable capacitive element is formed on a line between the signal line and ground.

When the variable capacitive element is inserted in this manner, the distance between the signal line and the ground is increased. Since a parasitic LCR increases with the increase of the distance, the characteristic of the impedance matching circuit is deteriorated. To make matters worse, the size of the device is increased.

### SUMMARY

According to an aspect of an embodiment, a variable capacitive element includes: a substrate; a signal line provided on the substrate; a movable electrode provided so as to cross over the signal line and having a first end and a second end which are fixed to the substrate; and a fixed capacitive portion provided between at least one of the first end and the second end of the movable electrode and the substrate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a configuration diagram of the conventional variable capacitive element;

FIG. 1B is a configuration diagram of the conventional variable capacitive element;

FIG. 1C is a graph showing a relation between a driving voltage and an electrostatic capacitance in a variable capacitive element;

FIG. 2 is a circuit diagram of an impedance matching circuit;

FIG. 3 is a plan view of a variable capacitive element according to an embodiment;

FIG. 4 is an equivalent circuit diagram of a variable capacitor shown in FIG. 3;

FIG. 5 is a cross-sectional view along A-A line in FIG. 3;

FIG. 6 is a cross-sectional view of a variable capacitive element according to a modification of the present embodiment taken along A-A line in FIG. 3;

FIG. 7 is a plan view of a variable capacitive element according to a comparative example;

FIG. 8 is an equivalent circuit diagram of the variable capacitive element shown in FIG. 7;

FIG. 9 is a plan view of a variable capacitive element according to another embodiment;

FIG. 10A is a cross-sectional view along A-A line in FIG. 9;

FIG. 10B is a cross-sectional view of a variable capacitive element according to a modification of the present embodiment taken along A-A line in FIG. 9;

FIG. 11 is a plan view of a variable capacitive element according to a still another embodiment;

FIG. 12 is an equivalent circuit diagram of the variable capacitive element shown in FIG. 11;

FIG. 13 is a circuit diagram of a communication module using a variable capacitive element;

FIG. 14A is a circuit diagram of an impedance tuner;

FIG. 14B is a circuit diagram of the impedance tuner;

FIG. 14C is a circuit diagram of the impedance tuner;

FIG. 14D is a circuit diagram of the impedance tuner; and

FIG. 15 is a configuration diagram of a communication device.

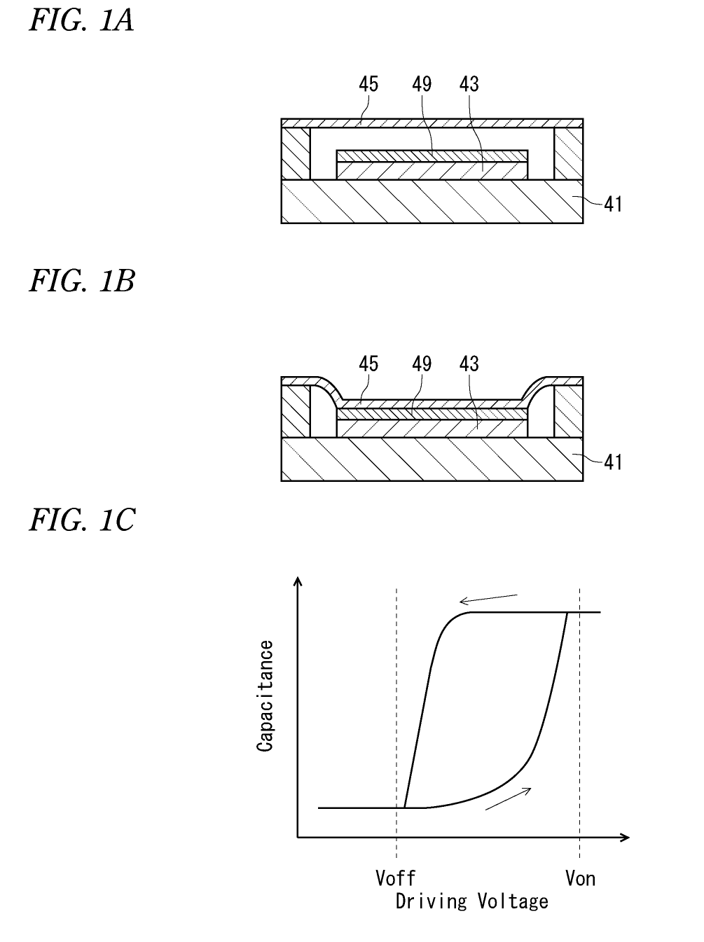

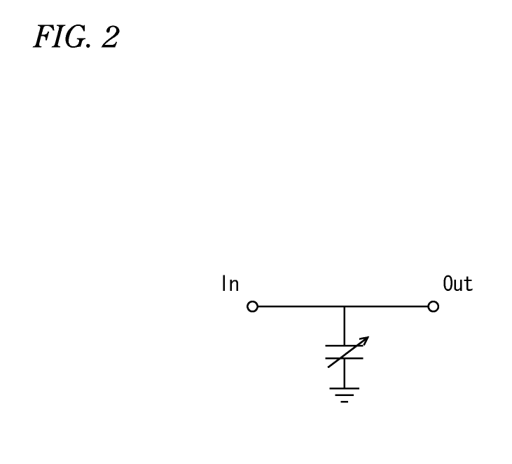

### DESCRIPTION OF EMBODIMENTS

Hereinafter, embodiments will be described.

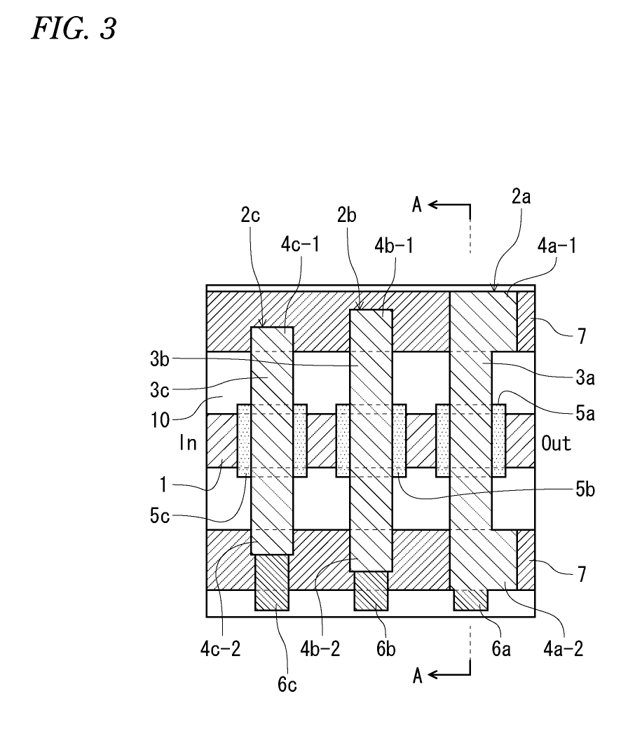

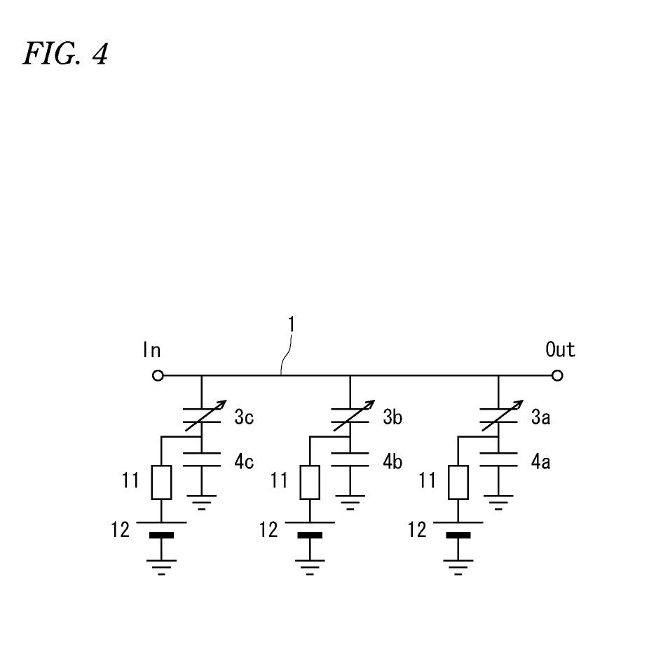

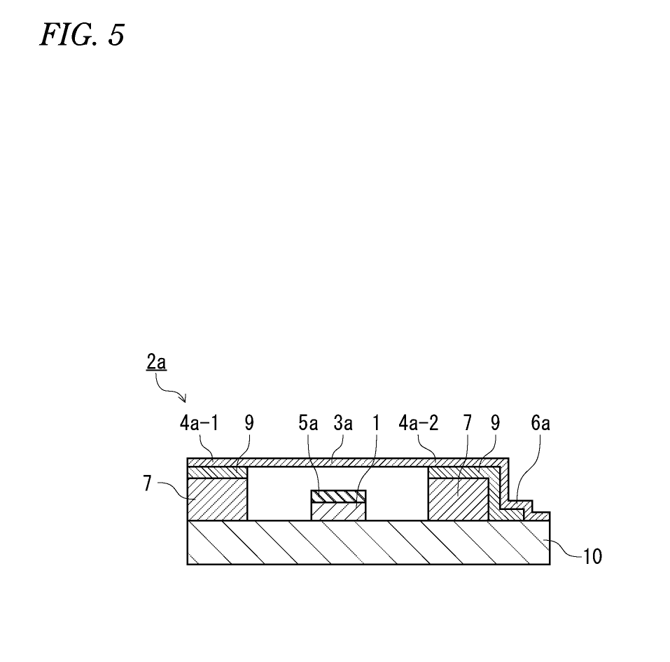

FIG. 3 is a plan view of a variable capacitive element according to an embodiment. FIG. 4 is an equivalent circuit diagram of a variable capacitor shown in FIG. 3. FIG. 5 is a cross-sectional view along A-A line in FIG. 3. In this embodiment, three variable capacitive elements 2a, 2b, and 2c are connected in parallel to a signal line 1. However, the number of variable capacitive elements is not limited to three.

As shown in FIG. 3, three movable electrodes 3a, 3b, and 3c are provided so as to cross over the signal line 1 on a substrate 10. The both ends of the movable electrodes 3a, 3b, and 3c are fixed to the substrate 10. The movable electrode 3a has fixed capacities 4a-1 and 4a-2 provided at the both ends. The movable electrode 3b has fixed capacities 4b-1 and 4b-2 provided at the both ends. The movable electrode 3c has fixed capacities 4c-1 and 4c-2 provided at the both ends. Namely, the variable capacitive elements are constituted of the movable electrodes facing the signal line 1 and the fixed capacities provided at the both ends of the movable electrodes. The three variable capacitive elements are connected in parallel to the signal line 1. Dielectric layers 5a, 5b, and 5c are respectively provided on the signal line 1 at positions facing the movable electrodes 3a, 3b, and 3c.

The variable capacitive elements 2a, 2b, and 2c have bias lines 6a, 6b, and 6c provided at their one end. The bias lines 6a, 6b, and 6c are connected to the movable electrodes 3a, 3b, and 3c and extend on the substrate 10. According to this constitution, the movable electrodes 3a, 3b, and 3c are drawn onto the substrate 10 through the bias lines 6a, 6b, and 6c. Although not illustrated in FIG. 3, RF blocks 11 and powers 12 are connected in series to the bias lines 6a, 6b, and 6c (see an equivalent circuit of FIG. 4).

As shown in FIG. 5, in the variable capacitive element 2a, both ends of the movable electrode 3a are electrically connected to upper electrodes of the fixed capacities 4a-1 and 4a-2. The upper electrodes face ground electrodes (lower electrodes) 7 provided on the substrate 10 through dielectric layers 9. Regions where the upper electrodes face the ground electrode 7 through the dielectric layers 9 are the fixed capacities 4a-1 and 4a-2. Namely, the ground electrodes 7 and the dielectric layers 9 are provided below the both ends of the movable electrode 3a, whereby the fixed capacities 4a-1 and 4a-2 are formed.

The upper electrode of the fixed capacitive portion 4a-2 is drawn to the substrate 10 by the bias line 6a. The dielectric layer 9 is also provided between the bias line 6a and the ground electrode 7. According to this constitution, the ground electrode 7 which is the lower electrode of the fixed capacitive portion 4a-2 is electrically separated from the bias line 6a connected to the movable electrode 3a. The bias line 6a is connected to, for example, the powers 12 (see FIG. 4) through the RF blocks 11. The cross-sectional views of the variable capacitive elements 2b and 2c are similar to FIG. 5.

When a voltage is applied between the signal line 1 and the movable electrodes 3a, 3b, and 3c, the electrostatic attractive force is generated in the signal line 1 and the movable electrodes 3a, 3b, and 3c, and the distance between the signal line 1 and the movable electrodes 3a, 3b, and 3c is changed. The capacity is also varied in response to the change of the distance. The capacity is maximum when the movable electrodes 3a, 3b, and 3c are in contact with the dielectric layers 5a, 5b, and 5c. The capacity is minimum when the electrostatic attractive force between the movable electrodes 3a, 3b, and 3c and the signal line 1 is minimum. The electrostatic attractive force is controlled by the driving voltage between the movable electrodes 3a, 3b, and 3c and the signal line 1. Therefore, the capacities of the variable capacitive elements 2a, 2b, and 2c can be controlled by the driving voltage.

As shown in FIG. 4, the powers 12 supplying the driving voltage are connected between the movable electrodes 3a, 3b, and 3c and the fixed capacities 4a, 4b, and 4c through the RF blocks 11. The fixed capacities 4a, 4b, and 4c serve as DC blocks.

The variable capacitive element is produced by using the MEMS techniques. The variable capacitive element is also called a variable capacitor.

As shown in FIGS. 3 and 5, the fixed capacities 4a-1 and 4a-2 at both ends of the variable electrode 3a have the upper electrodes of the same shapes and the capacities of the same value. When the fixed capacities 4a-1 and 4a-2 at both ends of the variable electrode have the same shapes and capacities, the occurrence of resonance can be prevented. Consequently, the variable capacitive element can be used in a wider frequency band. When the fixed capacities 4a-1 and 4a-2 have the same shapes, even if their capacities are different from each other, the occurrence of resonance can be prevented. Further, when the fixed capacities 4a-1 and 4a-2 have the same capacities, even if their shapes are different from each other, the occurrence of resonance can be prevented.

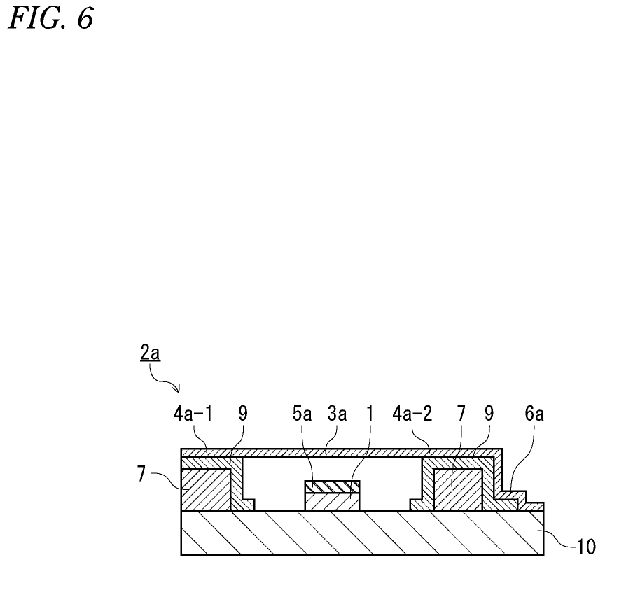

FIG. 6 is a cross-sectional view of a variable capacitive element according to a modification of the present embodiment. As shown in FIG. 6, the dielectric layers 9 in the present modification cover the lower electrodes at positions where the lower electrodes face the signal line 1. The dielectric layers 9 are provided between the lower electrodes and the signal line 1, whereby a leak current between the lower electrodes and the signal line 1 and a leak current between the lower electrodes and the movable electrode 3a can be controlled.

When the dielectric layer 9 is reduced in thickness in order to increase the electrostatic capacities of the fixed capacities 4a-1 and 4a-2, the leak current easily occurs between the movable electrode 3a and the lower electrodes of the fixed capacities. However, as shown in FIG. 6, the dielectric layers 9 are provided between the lower electrodes and the signal line 1, whereby the leak current can be suppressed.

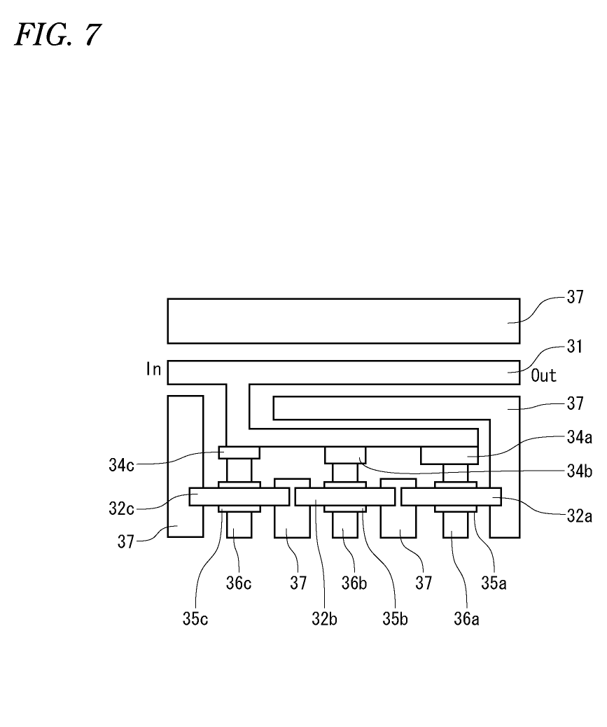

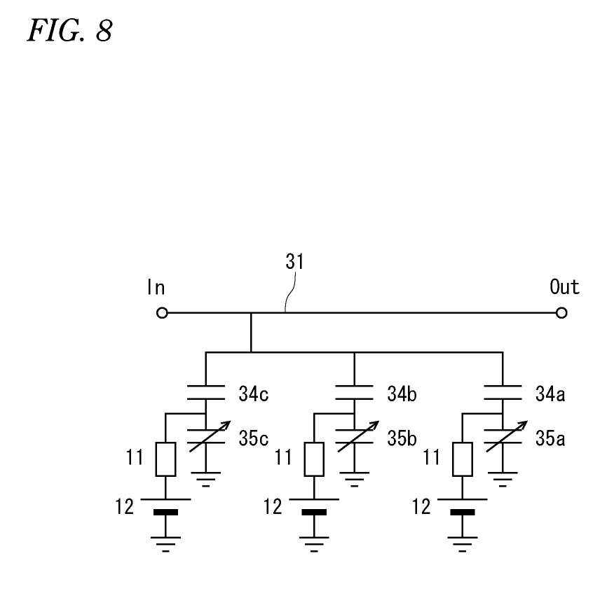

FIG. 7 is a plan view of a variable capacitive element according to a comparative example. FIG. 8 is an equivalent circuit diagram of the variable capacitive element shown in FIG. 7. As shown in FIG. 7, in the variable capacitive element according to the comparative example, fixed electrodes 36a, 36b, and 36c are connected to a signal line 31 through fixed capacities 34a, 34b, and 34c. The movable electrodes 32a, 32b, and 32c are provided so as to cross over the fixed electrodes 36a, 36b, and 36c. Both ends of the movable electrodes 32a, 32b, and 32c are connected to a ground electrode 37. As shown in FIG. 8, the powers 12 are connected to the fixed electrodes 36a, 36b, and 36c, straddled by the movable electrodes 32a, 32b, and 32c, through the RF blocks 11. As described above, the respective variable capacitive elements 35a, 35b, 35c are constituted of the fixed electrodes 36a, 36b, and 36c and the movable electrodes 32a, 32b, and 32c.

Compared with the configuration according to the present embodiment shown in FIG. 3, in the configuration according to the comparative example shown in FIG. 7, the distance from the signal line 31 to the variable capacitive element is longer. Therefore, since the parasitic LCR increases, the characteristic of the impedance matching circuit is deteriorated. Further, the size of the device is increased. Meanwhile, the movable electrodes 3a, 3b, and 3c shown in FIG. 3 are provided so as to cross over the signal line 1 connecting the input terminal In and the output terminal Out. Therefore, the distance from the signal line 1 to the variable capacitive element is reduced. Consequently, the parasitic LCR can be reduced. Further, the size reduction of the element can be realized.

Another embodiment will be described.

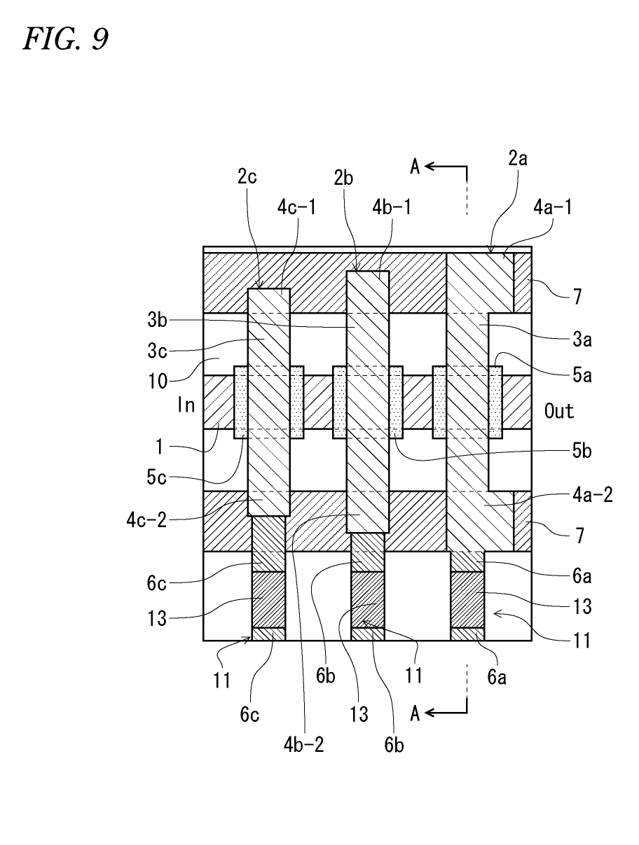

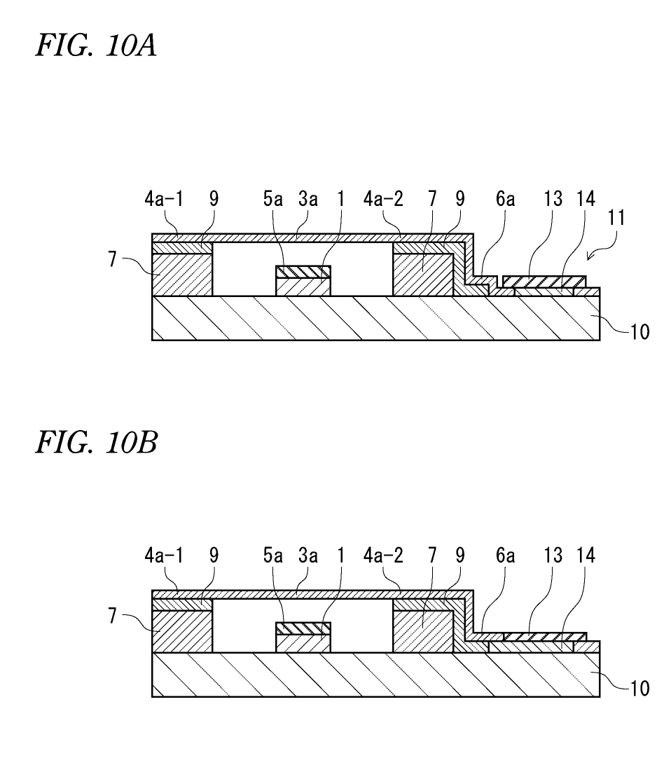

FIG. 9 is a plan view of a variable capacitive element according to another embodiment. FIG. 10A is a cross-sectional view along A-A line in FIG. 9. FIG. 10 B is a cross-sectional view of a variable capacitive element according to a modification of the present embodiment taken along A-A line in FIG. 9. The components of FIGS. 9, 10A, and 10B are assigned the same numbers as those in FIGS. 3 and 5.

As shown in FIGS. 9, 10A, and 106, the RF blocks 11 are formed on the substrate 10. The RF block 11 includes an SiCr film 14. The SiCr film 14 is provided on the substrate 10 and connected to the bias line 6a. The SiCr film 14 is covered by a protective film 13. The protective film 13 may be formed of an insulating film such as SiO₂, SiNx, or alumina.

A space between the signal line 1 and the movable electrode 3a may be formed by sacrifice layer etching. Since the SiCr film is easily damaged by the sacrifice layer etching, the protective film 13 is formed on the SiCr film 14.

In the present embodiment, although the SiCr film is used as a resistive film, a resistive film of other material may be used. For example, the resistive film may be formed of ZnO, W, Si, Fe—Cr—Al alloy, Ni—Cr alloy, or Ni—Cr—Fe alloy. A portion of the bias line 6a on the substrate 10 is used as a resistive film, whereby the RF block can be mounted on the substrate 10. According to this constitution, a chip part mounted with the RF block is not required to be separately provided. When the RF block is mounted on the substrate 10, the length from a power to a line can be reduced. Therefore, the characteristic deterioration due to the length of a line can be prevented.

A still another embodiment will be described.

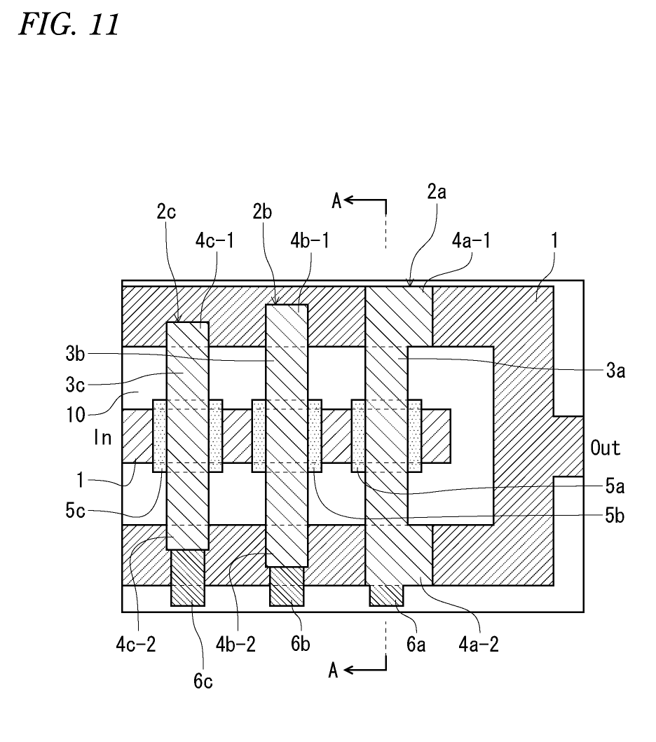

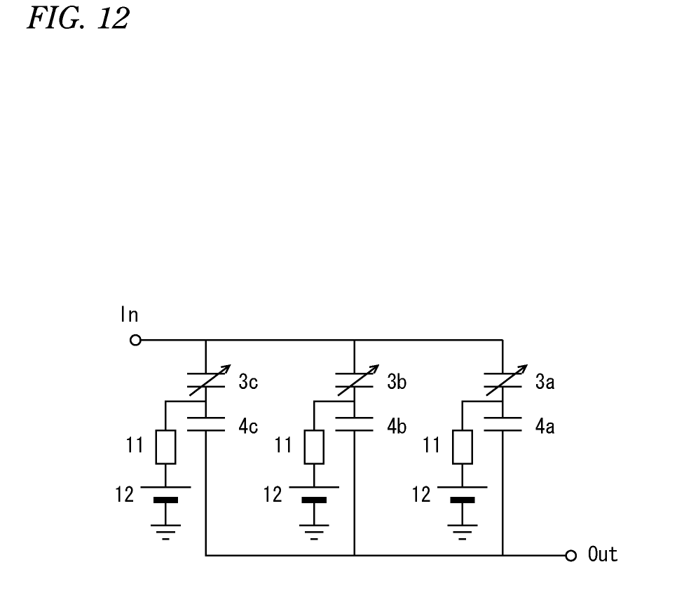

FIG. 11 is a plan view of a variable capacitive element according to a still another embodiment. FIG. 12 is an equivalent circuit diagram of the variable capacitive element shown in FIG. 11. The components of FIGS. 11 and 12 are assigned the same numbers as those in FIGS. 3 and 4.

In the embodiment shown in FIG. 3, the variable capacitive elements 2a, 2b, and 2c are connected in parallel to the signal line 1. Meanwhile, in the present embodiment shown in FIG. 11, the variable capacitive elements 2a, 2b, and 2c are connected in series to the signal line 1. The variable capacitive elements may be connected in series to the signal line.

As shown in FIG. 11, the lower electrodes of the fixed capacities are connected to the signal line 1 on the output terminal Out side. According to this constitution, the three variable capacitive elements 2a, 2b, and 2c can be connected in series to the signal line 1.

Another embodiment of the present embodiment will be described.

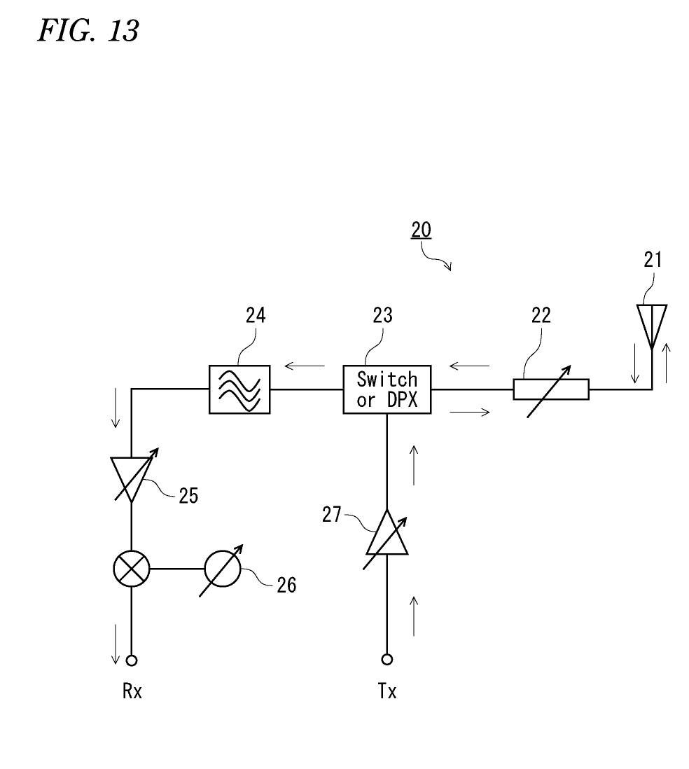

The present embodiment relates to a module using the variable capacitive elements in any of the above embodiments. FIG. 13 is a circuit diagram of a communication module using a variable capacitive element. As shown in FIG. 13, a communication module 20 is a module of an RF front end portion of a communication device. The communication module 20 adjusts the frequency band of a received signal and a transmission signal. The arrows of FIG. 13 show the flow direction of signals.

As shown in FIG. 13, the communication module 20 includes a tunable antenna 21, an impedance tuner (matching box) 22, a switch (or DPX) 23, a tunable filter 24, a tunable LNA 25, a tunable VCO 26, and a tunable PA 27.

The tunable antenna 21 can be freely adjusted in the directivity direction. The impedance tuner 22 is connected to between the tunable antenna 21 and the switch 23. The impedance tuner 22 adjusts impedance based on the condition around the antenna to optimize the impedance. The switch 23 branches the line from the tunable antenna 21 into a line on a transmission terminal Tx side and a reception terminal Rx side.

The line between the switch 23 and the reception terminal Rx is connected with the tunable filter 24 adjusting a pass frequency band, the tunable LNA 25, and the tunable VCO 26. The tunable LNA 25 is a low-noise amplifier for adjusting the efficiency, power, and frequency. The tunable VCO 26 is a communicator for adjusting the frequency.

The tunable PA 27 is connected to between the switch 23 and the transmission terminal Tx. The tunable PA 27 is a power amplifier for adjusting the efficiency, power, and frequency.

The variable capacitive elements in any of the above embodiments are mounted on at least one of the tunable antenna 21, the impedance tuner 22, the tunable filter 24, the tunable LNA 25, the tunable VCO 26, and the tunable PA 27. According to this constitution, the parasitic LCR can be reduced and, at the same time, downsized variable capacitive elements can be used. Therefore, a communication module with further improved characteristics and a smaller size can be provided.

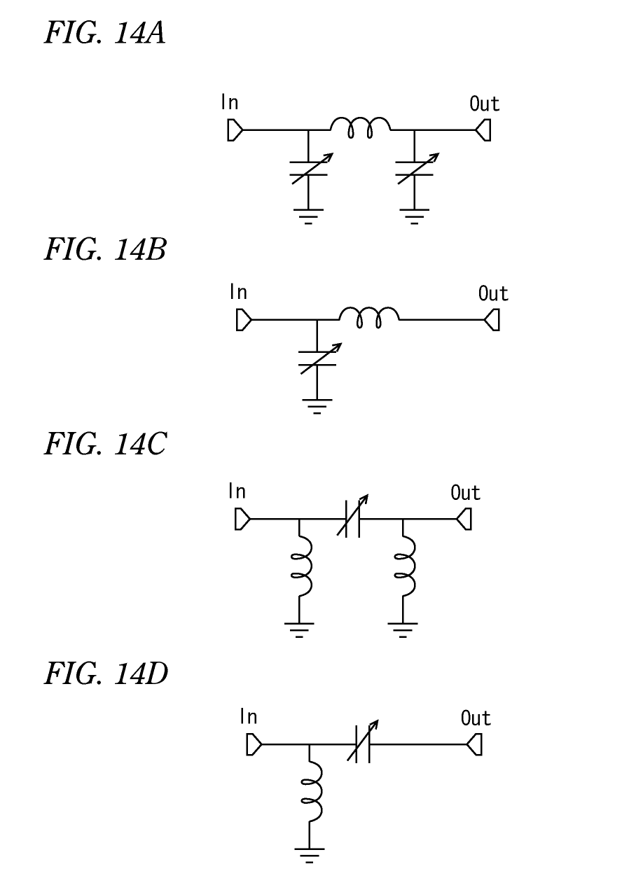

FIGS. 14A to 14D are circuit diagrams of the impedance tuner 22. The impedance tuner 22 shown in FIG. 14A includes an inductor, which is connected in series to the signal line connecting the input terminal In and the output terminal Out, and two variable capacitances connected in parallel to the signal line. The impedance tuner 22 shown in FIG. 14B includes one inductor connected in series to the signal line and one variable capacitance connected in parallel to the signal line. The impedance tuner 22 shown in FIG. 14C includes one variable capacitance connected in series to the signal line and two inductors connected in parallel to the signal line. The impedance tuner 22 shown in FIG. 14D includes one variable capacitance connected in series to the signal line and one inductor connected in parallel to the signal line. As the variable capacitances in FIGS. 14A to 14D, the variable capacitive elements in any of the above embodiments are used.

For example, one parallel variable capacitance shown in FIG. 14A or 14B may be formed of three variable capacitive elements, shown in FIG. 3, crossing over the signal line. The variable capacitive elements shown in FIGS. 14C and 14D may be the three variable capacitive elements shown in FIG. 11, for example. The number of the variable capacitive elements is not limited to three.

The module using the variable capacitive element is not limited to the communication module shown in FIG. 13. A module which includes at least one of the components included in the communication module shown in FIG. 13 is included in the present embodiment. Further, a module obtained by addition of another component to the communication module shown in FIG. 13 is included in the present embodiment.

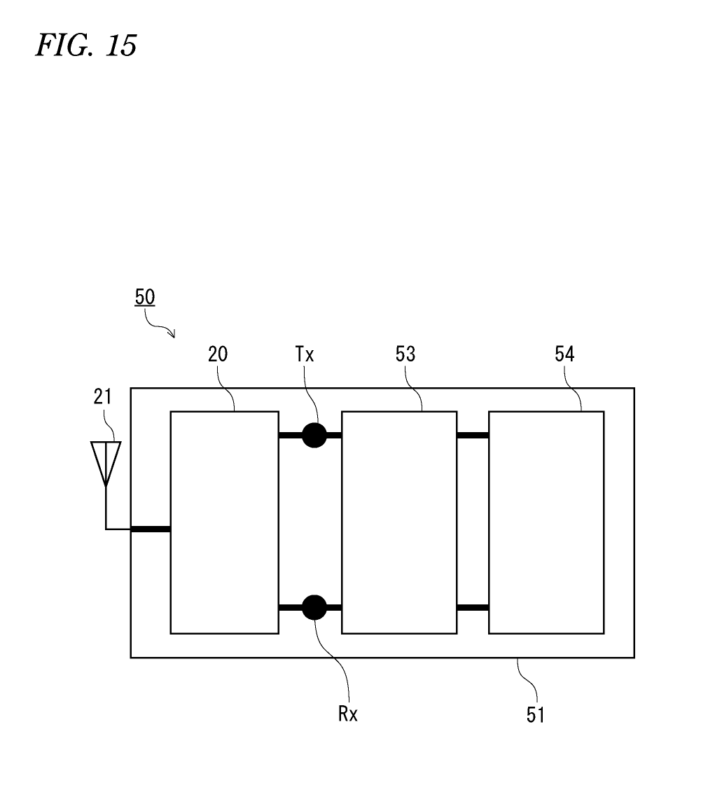

For example, a communication device including the communication module 20 shown in FIG. 13 is included in the present embodiment. FIG. 15 is a configuration diagram of a communication device. As shown in FIG. 15, a communication device 50 has on a module substrate 51 the communication module 20 of a front end portion shown in FIG. 13, an RFIC 53, and a base band IC 54.

The transmission terminal Tx of the communication module 20 is connected to the RFIC 53. The reception terminal Rx of the communication module 20 is connected to the RFIC 53. The RFIC 53 is connected to the base band IC 54. The RFIC 53 may be formed of a semiconductor chip and other components. A circuit including a receiving circuit for processing a received signal input from a reception terminal and a transmitting circuit for processing a transmission signal is integrated on the RFIC 53.

The base band IC 54 may be formed of a semiconductor chip and other components. A circuit for converting the received signal, received from the receiving circuit included in the RFIC 53, into an audio signal and packet data and a circuit for converting the audio signal and the packet data into the transmission signal to output the transmission signal to the transmitting circuit included in the RFIC 53 are integrated on the base band IC 54.

Although not illustrated, the base band IC 54 is connected with an output device such as a speaker and a display, and the audio signal and the packet data converted from the received signal by the base band IC 54 are output to the output device. The base band IC 54 is also connected with an input device such as a microphone and a button of the communication device 50. The base band IC 54 is constituted so that audio and data input by a user can be converted into the transmission signals. The configuration of the communication device 50 is not limited to the configuration shown in FIG. 15.

The single components such as the tunable antenna 21, the impedance tuner 22, the tunable filter 24, the tunable LNA 25, and the tunable VCO 26 shown in FIG. 13 are included in the present embodiment. Further, the variable capacitive element can be used for other than the above element.

In the above embodiments, although the fixed capacities are provided at both ends of the movable electrode, even if the fixed capacitive portion is provided at only one end of the movable electrode, the parasitic LCR can be reduced, and further size reduction can be realized.

In the embodiment, the fixed capacities provided at the both ends of the movable electrode may have a shape symmetrical to the signal line. When the fixed capacities at both ends of the movable electrode are symmetrically arranged (mirror-arranged) with respect to the signal line, resonance can be suppressed, and a stable characteristic can be obtained.

The values of the fixed capacities provided at a plurality of movable electrodes may be made different from each other. In this case, the variable capacitive element corresponding to various specifications can be realized. When the fixed capacities are provided at both ends of the movable electrode, the movable electrode and the fixed capacities can be arranged effectively.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A variable capacitive element comprising:
a substrate;
a signal line provided on the substrate;
a movable electrode provided so as to cross over the signal line and having a first end and a second end which are fixed to the substrate; and
a fixed capacitive portion provided between at least one of the first end and the second end of the movable electrode and the substrate.

2. A variable capacitive element comprising:
a substrate;
a signal line provided on the substrate;
a plurality of movable electrodes provided so as to cross over the signal line and having a first end and a second end which are fixed to the substrate; and
a fixed capacitive portion provided between at least one of the first end and the second end of the plurality of movable electrodes and the substrate,
wherein the values of the fixed capacitive portions provided at the plurality of movable electrodes are different from each other.

3. The variable capacitive element according to claim 1, wherein the fixed capacitive portions are provided at the first end and the second end of the movable electrode.

4. The variable capacitive element according to claim 3, wherein the fixed capacitive portions provided at the first end and the second end of the movable electrode are equal in at least one of capacity value and shape.

5. The variable capacitive element according to claim 3, wherein the fixed capacitive portions provided at the first end and the second end of the movable electrode have a shape symmetrical to the signal line.

6. The variable capacitive element according to claim 1, wherein the fixed capacitive portion includes an upper electrode connected to the movable electrode, a lower electrode provided on the substrate and facing the upper electrode, and a dielectric provided between the upper electrode and the lower electrode, and
the dielectric extends within a gap between the lower electrode and the signal line.

7. The variable capacitive element according to claim 6, further comprising a bias line connected to the movable electrode and extending on the substrate,
wherein the bias line is insulated from the lower electrode by the dielectric.

8. The variable capacitive element according to claim 1, wherein the fixed capacitive portion includes an upper electrode connected to the movable electrode, a lower electrode provided on the substrate and facing the upper electrode, and a dielectric provided between the upper electrode and the lower electrode,
the variable capacitive element further comprises a bias line connected to the upper electrode and extending on the substrate, and
the bias line is provided with a resistive film portion, and the resistive film portion is covered by a protective film.

9. A module including a variable capacitive element, comprising:
a substrate;
a signal line provided on the substrate;
a movable electrode provided so as to cross over the signal line and having a first end and a second end which are fixed to the substrate; and
a fixed capacitive portion provided between at least one of the first end and the second end of the movable electrode and the substrate.

10. A communication device provided with a module including a variable capacitive element, the variable capacitive element comprising:
a substrate;
a signal line provided on the substrate;
a movable electrode provided so as to cross over the signal line and having a first end and a second end fixed to the substrate; and
a fixed capacitive portion provided between at least one of the first end and the second end of the movable electrode and the substrate.
